(19) United States
(12) Patent Application Publication
(10) Pub. No.: US 2006/0004308 A1
(43) Pub. Date: Jan. 5, 2006

(54) Acupressure system and methods

(76) Inventor: Kimii Yamauchi, Arlington Heights, IL (US)

Correspondence Address: BANIAK PINE & GANNON, Suite 1200, 150 N. Wacker Drive, Chicago, IL, 60606-1606, US

(21) Appl. No.: 10/880,711

(22) Filed: Jun. 30, 2004

(51) Int. Cl. A61H 7/00

(52) U.S. Cl. 601/28; 601/134; 601/136; 606/204

(57) ABSTRACT

An acupressure massage pad formed of generally resilient material wherein the pad includes nodes that replicate the curvature of the apex of a human finger or knuckle to allow an individual to perform acupressure or reflexology massage without assistance.

### FIELD OF THE INVENTION

The present invention relates generally to a system and methods by which a user can apply acupressure to the user's foot or feet passively. More particularly, the invention relates to apparatus and methods through the use of which a user can apply acupressure to the user's foot or feet passively simply by standing on a mat having nodes of a size and shape, and arrangement as detailed herein.

### BACKGROUND OF THE INVENTION

Acupressure is described as an ancient healing art that was first developed in Asia some 5,000 years ago. Acupressure, like acupuncture and reflexology, seeks to free the energy or “qi” that are said to run in regular patterns, or “channels” throughout the body and over its surface. These channels, also called meridians, are described to be like rivers that flow through the body to maintain, irrigate, and nourish the tissues. An obstruction in the free flowing movement of these energy rivers are likened to a dam that causes the energy to back up, thereby creating imbalance and pain.

A practitioner of acupressure applies gentle uniform and firm manual pressure through his or her fingertips or knuckles on key points on the surface of the skin to stimulate the body, release muscular tension, and, overall, promote the circulation of blood and the body's energy in order to aid healing.

Rather than through the use of pressure applied through his or her fingertips, a practitioner of acupuncture inserts sterilized, stainless-steel needles (some as fine as a human hair) into specific acupuncture points located near or on the surface of the skin. Acupuncture points are said to be areas of designated electrical sensitivity. More specifically, the insertion of needles at these points is thought to stimulate various sensory receptors that, in turn, stimulate nerves that transmit impulses to the hypothalamic-pituitary system at the base of the brain. The hypothalamus-pituitary glands are responsible for the release of neurotransmitters and endorphins, the body's natural pain-killing hormones. It is estimated that endorphins are 200 times more potent than morphine. The substances released as a result of acupuncture are said to relax the whole body and regulate serotonin in the brain, the latter of which is known to play a role in human and animal disposition.

Stimulating the acupuncture points can influence the meridians such as by unblocking the obstructions at the dams and reestablishing the regular flow through the meridians. A more scientific explanation of acupuncture is that the stimulation of the certain energy trigger points of the body by acupuncture needles prompts the body to release certain hormones and chemicals that can reduce pain, regulate the endocrine system, and calm the nervous system.

Reflexology—the science of the application of acupressure—focuses on the nerve endings in the hands and feet for relaxation and to improve health. Reflexology stimulates the nerve ends and specific zones, called reflex zones, that correspond to areas of the body. The feet are important areas of stimulation and healing because many nerves stemming from all areas of the body terminate at the feet. The reflex zones in the feet are most commonly used in reflexology since these zones correspond to various parts of the body, including major organs and glands. More specifically, specific reflex zones in the feet correspond to ten energy zones of the body. By massaging certain areas on the feet, it is possible to bring a response in a corresponding, but remote organ, gland or tissue area of the body.

One accepted principle in reflexology is that various toxins, primarily acids and calcium, can accumulate and crystallize around the nerve endings. This crystallization is thought to impair the function of these nerve endings, and the organ, gland, or tissue that is served by these nerves. By massaging the various points on the feet, the crystallized deposits are thought to be removed, thereby restoring normal nerve function and ultimately health to the correlating organ, gland, or tissue. Stimulating an area—that does not necessarily have crystallized deposits—can stimulate a natural healing response in the correlating region of the body.

In reflexology, it is often necessary to apply pressure consistently over a specified period of time in order to promote the healing process. Manual application, either by the affected person or even a practitioner, of the required pressure for any extended period of time is generally impossible to achieve. Furthermore, it is virtually impossible for a person to manually self-stimulate many of these points and still be able to carry on other tasks.

A wide variety of mats are known on which individuals can stand and obtain a sensation. Some of these mats are sized for a single foot. Others are sized to cover large areas. Some include upper surfaces having elements that are readily pliable and collapse under the weight of an individual, thereby producing a “soft” feel to the foot. Others have raised features such as thin columnar projections that are used to produce an agitating sensation or textural elements that function to scrub the surface of the foot.

U.S. Pat. No. 4,329,981 to Dungl teaches a foot massage mat having what are described as “hill-like raised portions or protuberances” that press or squeeze the sole of the foot thereby causing an “agitation” of the different reflex zones. The raised portion or protuberances and the intermediately disposed valleys are described and shown as being “approximately the same size as a footprint of a healthy grown human”. The Dungl protuberances are sized and shaped to fit into the free space formed below the foot arch while simultaneously the heel and the region of the toe ball rests in the intermediately disposed valleys. More specifically, Dungl teaches that the height of the raised portion should be greater than the height of the arch of the foot. Dungl teaches the use of different sized mats in order to accommodate different size feet. In addition to the uniform arch sized raised portions, Dungl teaches a mat having a different sized pebble-like surface structure and a mat having a surface design of adjacently arranged naps.

U.S. Pat. No. 5,158,073 to Bukowski teaches an acupressure foot massage mat having an upper surface from which protrude a multiplicity of conic structures—formed from a material to provide a firm point pressure to a foot—in a random dispersal pattern. Bukowski teaches that the conic structures have different diameters and lengths. Bukowski teaches that the conic structures have corresponding conic cavities opening from the lower surface of the mat in order to enhance the non-slip surface by functioning as suction cups that temporarily adhere to a smooth surface to prevent slipping.

U.S. Pat. No. D294,212 to Siai et al. discloses a seating pad including an upper surface pattern of what appears to be two types of generally identical hemispherical protrusions and a bottom surface of generally truncated cones.

U.S. Pat. No. D194,255 to Altmeyer et al. teaches a foot exerciser that is of oval shape and includes a multiplicity of pointed protrusions that are shown to vary in height from the center to the edges.

A demand therefore exists for a system and method by which an individual can apply the same or generally the same amount and type of pressure to his or her foot or feet that an acupressure practitioner would apply, but passively and without the need for the services of the acupressure practitioner. The present invention satisfies this demand.

### SUMMARY OF THE INVENTION

The acupressure methods and systems of the present invention is designed to allow an individual to self-perform acupressure, that is, without assistance of an acupressure practitioner, and passively simply by standing on the apparatus and utilizing the relevant methods described herein.

The system of the present invention includes a pad sized and shaped to accommodate at least one foot of an individual. The pad, in one preferred embodiment, is formed or molded in one-piece of a pliable plastic material of moderate rigidity, that is, a material that slightly, but not completely deforms upon application of that pressure generally generated by a foot of a standing adult. The system and method is especially effective where the pad comprises a flexible polymeric selected from the group consisting of polyurethane, natural rubber, synthetic rubber, natural elastomers and synthetic elastomers. One preferred embodiment of the pad includes a bottom surface that is non-slip and a top surface that includes a plurality of nodes.

The pad includes an upper surface which is of a size and shape to accommodate all or a portion of a single adult foot. Preferably, the pad upper surface is of a size and shape so that one or both feet of an adult can be comfortably accommodated thereon while the pad is positioned in the desired application site. For example, a pad that is intended for use in a generally rectangular shaped application—such as on the inner horizontal surface of bathtub—may have width and length dimensions that are unequal to provide a generally rectangular or oval shape, while a pad intended for positioning on the floor of a square-shaped shower stall may have generally equal dimensions to provide a generally square or circular shape. The pad may have other sizes and shapes—to satisfy space or application limitations or aesthetics.

So that the pad may be used without the pad slipping out from under the individual, thereby possibly causing the individual to fall, the pad in one preferred embodiment includes a bottom surface having non-slip features. Examples of such non-slip features include roughened or ribbed surface treatments or suction cup-like elements or an adhesive suitable to prevent the mat from slipping or sliding. The embodiment of the pad with a bottom surface having such non-slip features allows the pad to be safely used in wet applications—such as in a shower or bath—or in dry applications—such as the smooth tile or polished wood floor found in kitchens (e.g., in front of the sink).

The top surface of the pad preferably includes a smooth surface, with a generally non-slip texture that includes an array of nodes positioned to render a non-agitating acupressure effect to a person standing thereon. In one preferred embodiment of the node array, each of the nodes are of a generally convex shape and sized and shaped according to the size and shape of the tip of an adult human finger or the upper surface of an adult hand knuckle and those portions that are immediately adjacent to these areas of an adult human body. Another embodiment of the nodes is shaped similar, but sized slightly proportionally larger than the size of the tip of an adult human finger or hand knuckle. For purposes of this application, nodes having the size and shape of an adult human finger tip or hand knuckle will be termed “finger tip nodes”. The finger tip nodes are organized on the top surface of the pad so that the user may comfortably and passively stimulate—that is, apply that type of directly firm pressure that an acupressure practitioner would provide to produce what is generally believed to be a soothing experience—but not agitate—that is, cause what is generally believed to be an uneasy or discomforting or generally painful reaction—to one or both of his or her feet. To this end, and in order to avoid over stimulation and/or to allow the user to experience the soothing sensation produced by the pad in a controlled fashion one foot at a time, and to prevent agitation of the user's foot or feet, the pad may include a rest portion having a limited number of or no finger tip nodes. One preferred embodiment of the rest portion includes a configuration or material having a non-slip surface texture of on or in which the user's foot or feet may rest. Maximum benefit is obtained when an individual places his or her foot or feet onto the stimulation portion of the pad and the foot or feet are bare or are covered by a thin-layered sock.

It is, accordingly, a general object of the present invention is to provide an easy and efficient system and methods by which acupressure massage may be provided passively and without the assistance of another in a planned or controlled manner to a user's foot or feet.

Another object of the present invention is to provide acupressure massage passively without the assistance of another through the use of a pad having an array of finger tip nodes, each node of which is sized and shaped to simulate the tip of an adult finger or an adult hand knuckle and the portion generally adjacent to the same.

It is another object of the present invention to provide a new and improved pad for massage that is easy to maintain, store, and transport.

These and other objects and advantages of the present invention are apparent from the subsequent detailed description of the preferred embodiment and the claims taken in conjunction with the accompanying drawings.

### BRIEF DESCRIPTION OF THE DRAWINGS

FIG. 1 is a top view of a pad constructed according to one embodiment of the present invention.

FIG. 2 is a top view of a pad constructed according to another preferred embodiment of the present invention and including a stimulation area and a rest portion.

FIG. 3 is a top view of a pad constructed according to an additional preferred embodiment of the present invention and including a stimulation area, having separate stimulation array areas of finger tip nodes, and a rest portion.

FIG. 4 is a fragmentary sectional view of a pad taken substantially along line 4-4 shown in FIG. 2, with a human finger also shown to further identify the size and shape of one preferred embodiment of a finger tip node according to the invention.

FIG. 5 is a fragmentary sectional view of a pad taken substantively along line 5-5 shown in FIG. 3, with a human finger shown to further identify the relative size and shape of preferred embodiments of different finger tip nodes according to the invention and also to identify a preferred embodiment of the non-slip features.

FIG. 6 illustrates the details of the use of a preferred embodiment of the invention that is sized and shaped for an application and that includes a stimulation area and a rest portion on which one or more feet may be placed.

FIG. 7 illustrates the details of an additional preferred embodiment of the invention including a stimulation area and a rest portion on or in which one or more feet can be placed.

### DETAILED DESCRIPTION

A system that permits an individual to passively apply acupressure to his or her feet according to the present invention is identified in the accompanying drawings as 21. The system 21 includes a pad 31.

The pad 31 includes a base 33 having an upper surface 51 and lower surface 41 and surrounding edge wall 37. The pad 31 may include a border 108 adjacent to and along the surrounding edge wall 39 of the pad 31.

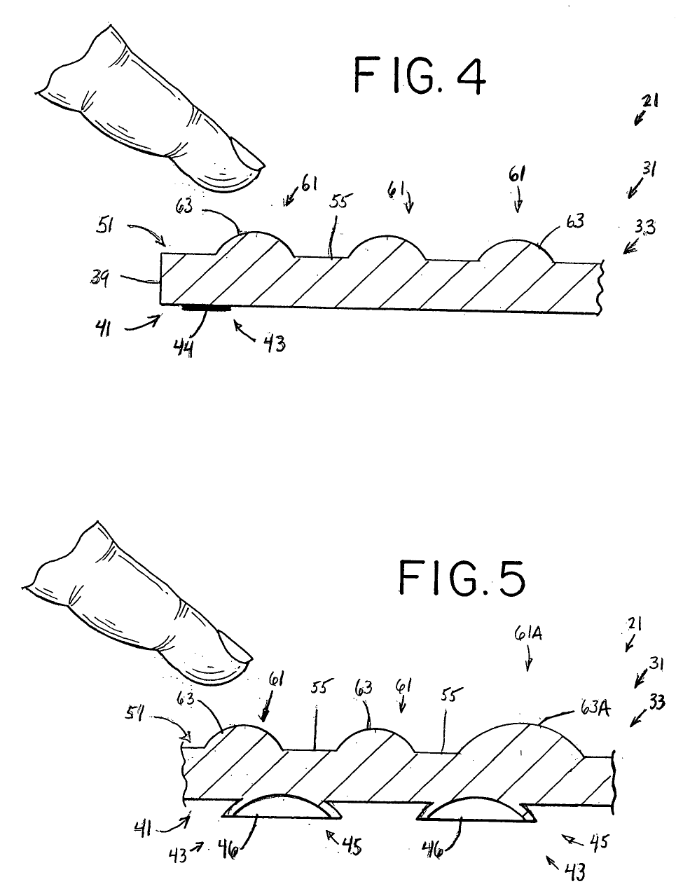

So that the pad 31 may be used not only in applications and on application surfaces 301 that are wet but also on generally smooth or glossy, embodiments of the present invention may include a base 33 having a lower surface 41 with one or more non-slip features 43. Such features 43 may include a non-slip composition, texture, and/or structure. One example of a non-slip feature 43 is a gripping element 44. The gripping element 44 can be a composition or a texture exposed at or forming a part or all of the lower surface 41 so as to facilitate general releasable or non-releasable adherence to the application surface 301. An example of a gripping element 44 is an adhesive layer shown in FIG. 4. Another example of a non-slip feature 43 is a structural element 45. Raised flexible elements that can adhere to an application surface 301 through suction developed within a cavity 46 thereby lessen the tendency of the pad 31 to slip over a smooth or glossy or wet surface 301. FIG. 5. illustrates one embodiment of such structural elements 45, commonly known as “suction cups”.

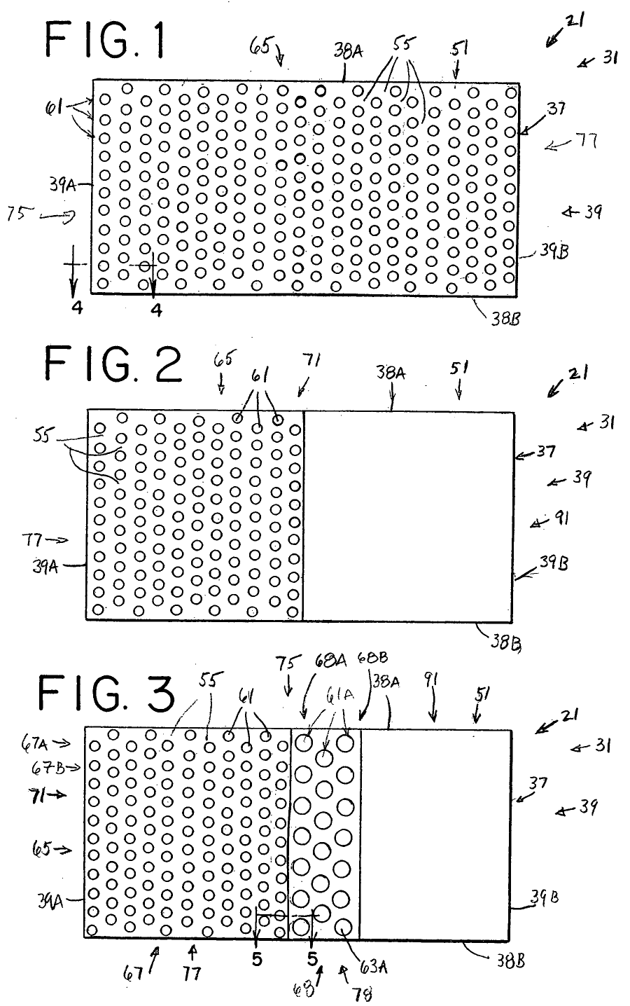

In certain embodiments, such as those illustrated in FIGS. 1-6, the base 33 is formed, such as through molding, into a generally sheet-like structure 34 and made from a flexible material or materials, such as types of plastic, rubber, or composites, so that the pad 31 may form a generally flat surface even on application surfaces 301 that are not totally flat. For wet applications, the material from which the pad 31 is made is water resistant.

Other embodiments of the system 21 include a pad 31 having a base 33 formed to include walls 91 that raise and space the upper surface 51 significantly above the application surface 301. FIG. 7 illustrates one such embodiment of a pad having such walls 91.

A plurality of finger tip nodes 61 rise above the pad 31 and over the upper surface 51 such that an inter-nodal surface 55 extends between the nodes 61. The finger tip nodes 61 are preferably distributed over a portion or generally all of the upper surface 51 of the pad 31 so that a user can achieve contact between at least a portion of one of his or her feet and more of the surfaces 63 of the nodes 61 on the upper surface 51.

Each node 61 is generally rounded and semi-spherical in shape. More specifically, each node 61 has a shape that simulates the curvature of the apex of the human finger tip or knuckle that is used to produce acupressure and conduct reflexology exercises and, rather than a sharp sensation to a specific point on a foot, a more general localized sensation to the foot. A foot placed on a finger tip node 61 of the present invention receives a general pressure to an area similar to that delivered by a practitioner when he or she uses his or her finger tip or knuckle to apply pressure to the foot. While the base 33 and finger tip nodes 61 may be separately formed and subsequently joined together, the base 33 and nodes 61 may also be of a unitary construction, such as molded in one piece out, for example, of a pliable plastic material of moderate rigidity or a rubber material.

In order to generally replicate the acupressure effect, each finger tip node 61 has an upper node surface 63 having a size and shape generally identical or proportional to the tip of an adult finger or the surface of an adult hand knuckle. FIG. 4 provides a comparison of the shape of upper node surface 63 and an human adult index finger. The nodes 61 shown in the FIGS. 2 and 4 embodiment of the pad 31 are generally identical to the size and shape of an adult finger. The nodes 61 shown in the FIG. 5 embodiment of the pad 31 are not uniform in size and include nodes 61 that are not only, generally identical to the size and shape of an adult finger tip, but also nodes 61A that are generally proportional to, but slightly larger than the tip of an adult finger.

One embodiment of pad 31 is illustrated in FIG. 1 and includes base 33 having a surrounding edge wall 37—organized to form length edge walls 38A, 38B and width edge walls 39A, 39B in which the walls 38A, 38B are longer than the walls 39A, 39B so as to provide a generally rectangular shape. One preferred embodiment of a pad 31 having such a shape may have one length edge walls 38A, 38B of 28 inches and width edge walls 39A, 39B of 16 inches. A pad 31 having a base 33 of such dimensions can fit on an application surface 301 such as the surface of a bathtub and accommodate both feet of a user thereon. However, as explained, the overall dimensions of the pad 31 may be of varying dimensions in order to facilitate use of the pad 31 in different applications. The nodes 61 are arranged on the upper surface 51 of the embodiment of the pad 31 shown in FIG. 1 to form a node array 65 that extends across generally the entire upper surface 51 and, so that the entire surface 51 constitutes a stimulation area 71. As a result, a user can make contact between his or her foot or feet and any one or more nodes 61 simply by stepping onto the pad 31. The user can take a rest from the further application of acupressure to his or her feet by stepping off the pad 31.

Another preferred embodiment of the pad 31 is shown in FIG. 2. The FIG. 2 embodiment of the pad 31 includes a stimulation area 71 of the pad 31—formed from nodes 61 organized in a node array 65—and a rest area 91—that includes no nodes 61. The rest area 91 is sized and shaped to allow a user to remain on the pad 31 yet avoid engagement with nodes 61 so as not to receive acupressure on one or more of his or her feet.

An additional preferred embodiment of the pad 31 is shown in FIG. 3. The FIG. 3 embodiment of the pad 31 includes a stimulation area 71—that includes a node array 65—and a rest area 91. More specifically, the node array 65 includes a first node arrangement 67 of nodes 61 to form a first stimulation portion 77 of stimulation area 71 and an added node arrangement 68 of nodes 61A to form an added stimulation portion 78 of stimulation area 71. Because nodes 61A are proportionate to, but slightly larger than those nodes 61 in stimulation portion 67, a user may provide sensation to his or her foot by stepping onto stimulation portion 78 that is different and more generalized from that which is provided by the nodes 61 in stimulation portion 77. Each of the areas 71 and 91 of the FIG. 3 embodiment of pad 31 preferably are of dimensions so that a user can place at least one of his or her feet thereon. For example, in one embodiment the area 71 may have an approximate width of 15 inches and an approximate length of 12 inches. While the nodes 61, 61A may be arranged to form other patterns in the embodiments of pad 31, the nodes 61 in the FIG. 3 embodiment are organized—as are the nodes in the FIGS. 1 and 2 embodiments—in a first node arrangement 67 of columns 67A and rows 67B and while the nodes 61A are organized in an added node arrangement 68 of columns 68A and rows 68B. The number of columns 67A, 68B, and rows 68A, 68B may vary. The FIG. 3 embodiment includes a first node arrangement 67 of eleven columns 67A and twenty-two rows 67B of nodes 61. In the illustrated embodiment, each node 61 is generally equally spaced apart from each other. Each node 61 of area 71 may measure approximately ½ to ⅞ inch in diameter and ½ inch high from the top surface 101 of the pad 31 to the highest point “A” of the node 61.

Each of the nodes 61A of the added stimulation portion 78 of the FIG. 3 embodiment is proportionately larger than the nodes 61 in first node arrangement 67. More specifically, the nodes 61A can measure 1 to 1¾ inch in diameter and measure ¾ inch high from the top surface 101 of the pad 31 to the highest point A1 of the node 61A.

The rest area 91 includes no nodes 61, 61A. The upper surface 51 of the rest area 91 of the preferred embodiment shown in FIG. 3, while generally smooth, has a texture or finish or surface layer to provide a non-slip surface. A user may place portions or all of his or her foot or feet into the rest area 91 so the user may selectively exclude areas of the foot from receiving acupressure. The rest area 91 may be sized to accommodate an entire foot or both feet at the same time.

The pad 31 shown in FIG. 3 can be placed on any surface including one having a carpet or a tile floor. The bottom surface 103 of the illustrated embodiment includes structural elements 45—that is, “suction cups”—to prevent the mat from slipping or sliding. The non-slip surface on the bottom surface allows the pad 31 to be safely used in the shower or bath or on a tile floor such as in the kitchen in front of the sink.

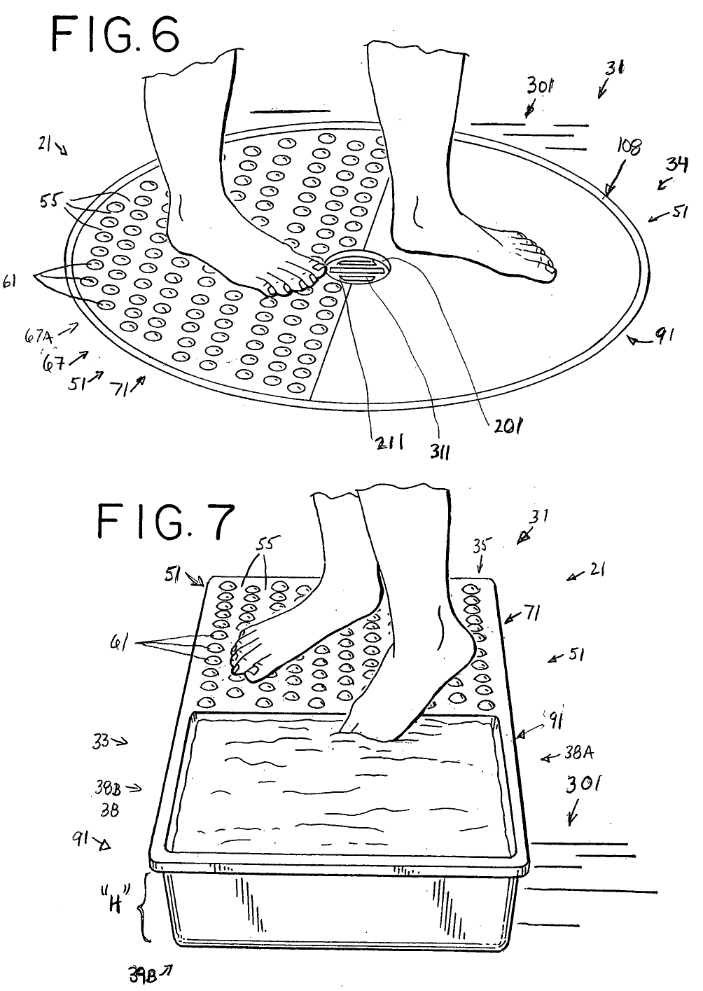

FIG. 6 illustrates another embodiment of pad 31. The border 108 of the pad 31 defines a generally oval shape for this embodiment. The FIG. 6 embodiment of this pad 31 includes a stimulation area 71—including a node array 65 of nodes 61 arranged in columns 67A and rows 67B—and a rest area 91 plus an aperture wall 201—defining an aperture 211 which may, for example, be placed over a drain 311 opening through application surface 301 such as in a shower area.

FIG. 7 illustrates another preferred embodiment of pad 31 that includes a base 33 having an edge wall 37 organized to form length edge walls 38A, 38B that oppose width edge walls 39A, 39B with the walls 38A, 38B and 39A, 39B having a height “H” so as to space the upper surface 51 from the application surface 301. The upper surface 51 includes an upper surface support 35 and edge walls 38A, 38B and 39A, 39B having sufficient resiliency to support the weight of an adult standing on the upper surface 51. Additionally, the walls 38A, 38B, and 39A, 39B are generally impermeable and the rest area 91 is depressed relative to the stimulation 71 area to provide a receptacle 99 as an element of the rest area 91 in which a fluid may be placed so that a user may soak one or more of his or her feet.

While the present inventions and what is considered presently to be the best modes thereof have been described in a manner that establishes possession thereof by the inventors and that enables those of ordinary skill in the art to make and use the inventions, it will be understood and appreciated that there are many equivalents to the exemplary embodiments disclosed herein and that myriad modifications and variations may be made thereto without departing from the scope and spirit of the inventions, which are to be limited not by the exemplary embodiments but by the appended claims.

I claim:

1. An acupressure pad comprising:
a pad including an upper surface, a lower surface generally opposing to said upper surface, and a surrounding edge wall,
a node array formed from a plurality of finger tip nodes that rise above said upper surface, each of said finger tip nodes having a generally round and semi-spherical shape proportionate to an adult human finger tip or a hand knuckle,
said node array defining a stimulation area on which a user can place his or her feet and receive non-sharply directed pressure on his or her feet.
